(19) United States
(12) Patent Application Publication
(10) Pub. No.: US 2005/0153162 A1
(43) Pub. Date: Jul. 14, 2005

(54) Ag-base interconnecting film for flat panel display, Ag-base sputtering target and flat panel display

(75) Inventors: Katsutoshi Takagi, Kobe-shi (JP); Junichi Nakai, Kobe-shi (JP); Katsufumi Tomihisa, Kobe-shi (JP); Yuuki Tauchi, Kobe-shi (JP); Toshihiro Kugimiya, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 10/999,027

(22) Filed: Nov. 30, 2004

(30) Foreign Application Priority Data
Dec. 4, 2003 (JP) 2003-405476
Sep. 3, 2004 (JP) 2004-257632
Oct. 6, 2004 (JP) 2004-293187

(51) Int. Cl. B32B 15/01

(52) U.S. Cl. 428/673

(57) ABSTRACT

An active matrix flat panel display includes pixels, TFTs for driving the pixels, and interconnecting lines connected to the TFTs. The interconnecting lines are formed by processing an interconnecting film of an Ag-base alloy containing 0.1 to 4.0 at % Nd and/or 0.01 to 1.5 at % Bi, and Ag as the remainder or an Ag-base alloy containing, in addition to Nd and/or Bi, one or some of elements including Cu, Au and Pd in a content in the range of 0.01 to 1.5 at %.

### BACKGROUND OF THE INVENTION

1. Field of the Invention

The present invention relates to a sputtering target for depositing an interconnecting film or an interconnecting film for a flat panel display (hereinafter, abbreviated to “FPD”) by a sputtering process and to a FPD provided with an interconnecting film or an interconnecting film formed by sputtering using the sputtering target.

2. Description of the Related Art

FPDs include liquid crystal displays (LCDs), such as amorphous silicon thin film transistor (TFT) LCDs and polysilicon TFT LCDs, field emission displays (FEDs), electroluminescence displays (ELDs), such as organic/inorganic ELDs, and plasma display panels (PDPs). FPDs are classified by pixel driving system into active matrix FPDs (TFT-driven FPDs) and passive matrix FPDs.

Referring to FIG. 2, the active matrix FPD has many pixels each provided with a transparent electrode (or a reflecting electrode) 1 and a TFT 2 for driving the pixel. The TFT has interconnecting films serving as a gate electrode 4, a source electrode 6 and a drain electrode 7. Address lines 3 are extended longitudinally and data lines 5 are extended laterally in spaces between the pixels. Each address line 3 is connected to the gate electrodes 4 of the TFTs 2. Each data line 5 is connected to the source electrodes 6 of the TFTs 2. The drain electrode 7 of each TFT 2 is connected to the transparent electrode 1. The required characteristics of the address lines 3, the data lines 5, the gate electrodes 4, the source electrodes 6 and the drain electrodes 7 are different from those of the transparent electrode (or the reflecting electrode) 1. Films forming the address lines 3, the data lines 5, the gate electrodes 4, the source electrodes 6 and the drain electrodes 7 will be generically called interconnecting films in this specification.

The passive matrix FPD does not have any components corresponding to the TFTs of the active matrix FPD. As shown in FIG. 3, the passive matrix FPD has a transparent upper substrate 21, such as a glass substrate, a transparent lower substrate 22, such as a glass substrate, parallel, scanning electrodes 23 formed on the inner surface of the upper substrate 21, parallel, data electrodes 24 formed on the inner surface of the lower substrate 22 so as to extend perpendicularly to the scanning electrodes 23, and a liquid crystal filling up the space between the upper substrate 21 and the lower substrate 22. Voltages are applied to the scanning electrodes 23 and the data electrodes 24 to make pixels visible. Films forming the scanning electrode 23 and the data electrodes 24 will be generically called interconnecting films in this specification. Active matrix FPDs and passive matrix FPDs will be inclusively called FPDs.

The interconnecting film is formed of an Al alloy excellent in electrical conductivity, heat resistance and fine patterning by wet etching. Interconnecting films having still lower electrical resistivity and still higher heat resistance have been demanded in recent years with the progressive increase in the screen size of FPDs and demands for higher definition FPDs and diversification of FPDs. Fabrication of some high-definition FPD requires an interconnecting film capable of being finely patterned. Requisite characteristics of the interconnecting film will be explained.

Importance of low electrical resistivity will be explained. A FPD of a large screen size, such as a large television set, needs longer interconnecting lines formed by processing an interconnecting film. A high-definition FPD, such as a high-picture-quality television set, of higher resolution needs narrower interconnecting lines of an interconnecting film. Longer or narrower interconnecting lines have a higher electrical resistance that delays the conduction of electrical signals. It is preferable to form interconnecting lines of a material having a low electrical resistivity to suppress the delay of conduction of electrical signals. Interconnecting lines having a low electrical resistivity of, for example, 3.0 μΩcm cannot be formed of conventional Al-base alloys. Thus Ag-base alloys capable of forming interconnecting lines having an electrical resistivity of 3.0 μΩcm or below are attractive materials for forming the foregoing interconnecting lines.

Importance of high heat resistance will be explained. New FPDs, such as low-temperature polysilicon TFT LCDs have been marketed in recent years in addition to the conventional amorphous silicon TFT LCDs and FPDs have been progressively diversified. Interconnecting lines undergo high-temperature heating in special manufacturing processes for manufacturing those new FPDs. For example, an activation process for activating polysilicon in a manufacturing process for manufacturing the low-temperature polysilicon TFT LCD heats the interconnecting lines at a temperature between 450 and 500° C. in a vacuum by one cycle of a heating process. A sealing process included in a FED manufacturing process heats interconnecting lines at a temperature between 450 and 500° C. in the atmosphere by several cycles of a heating process. The interconnecting lines of the conventional amorphous silicon TFT LCD are not required to be resistant to such high-temperature heating. Thus high heat resistance is a new requirement brought about by new FPDs. It is difficult for conventional Al-base alloys to cope with high heat resistance necessary to withstand high-temperature heating at high temperatures in the range of 450 to 500° C. Therefore, Ag-base alloys capable of coping with such a requirement are attractive materials for forming the foregoing interconnecting lines.

Importance of fine patterning will be explained. The width of the interconnecting lines of the FPD decreases with the increase of the resolution of the FPD. Generally, the finely patterned interconnecting lines of the FPD are formed in a desired shape by etching an interconnecting film by a wet etching process. Since the control of the shape of the narrow interconnecting lines is difficult, it is desirable to form the interconnecting lines by processing an interconnecting film capable of being easily and finely patterned. Generally, films of Ag-base alloys characterized by their excellent low resistivity and high heat resistance are etched at a high etching rate, and side surfaces of interconnecting lines of Ag-base alloys are etched at a high side etching rate. Therefore, control of the shape of interconnecting lines of Ag-base alloys is difficult and the fine patterning of interconnecting lines of Ag-base alloys having a width of 10 μm or below needs to be improved. Difficulty in fine patterning is not a problem with processing wide reflecting electrode films and reflecting films and is a problem with processing interconnecting films to form narrow interconnecting lines.

Various Ag-base alloys for forming interconnecting films having such required low electrical resistivity and high heat resistance have been proposed. An Ag-base alloy containing 0 to 25 wt % Ru and 0 to 25 wt % Cu was proposed in JP-A 2001-102325. An Ag-base alloy containing 0.1 to 3 wt % Pd and 0.1 to 3 wt % Al, Au, Pt, Cu, Ta, Cr, Ti, Ni, Co, and Si was proposed in JP-A 2001-192752. An Ag-base alloy containing 0.1 to 10 wt % Au and 0.1 to 5 wt % Cu, Al, Ti, Pd, Ni, V, Ta, W, Mo, Cr, Ru, and Mg was proposed in JP-A2002-140929. An Ag-base alloy containing 0.1 to 2 at % Sc, Y, Sm, Eu, Tb, Dy, Er, and Yb and 0.1 to 3 at % Cu and Au was proposed in JP-A 2003-113433. Thin films for forming interconnecting lines proposed in JP-A 2004-126497 and JP-A 2003-293054 are formed of Ag-base alloys containing Au, Cu, Ti and Zr. A laminated film having a low electrical resistivity, for forming interconnecting lines, proposed in JP-A 2004-2929 consists of an alloy film formed of an alloy containing at least Ag or Cu as a principal component, and a silicide film. A laminated film having a low electrical resistivity, for forming interconnecting lines, proposed in JP-A2004-76079 consists of an alloy film of an alloy containing at least Ag or Cu as a principal component, and a nitride film. An Ag-base alloy for forming reflecting electrode films and reflecting films, which are processed in large sizes as compared with the films for forming interconnecting lines, contains 0.1 to 3.0 at % Nd and Y, 0.1 to 2.0 at % Cu and 0.1 to 1.5 at % Au was proposed in JP-A 2002-323611. A reflecting film formed of an Ag-base alloy containing 0.01 to 4 at % Bi and/or Sb was proposed in JP-A 2004-76080.

The interconnecting films of Ag-base alloys proposed in the foregoing patent documents for forming interconnecting lines of FPDs are classified roughly into interconnecting films of Ag-base alloys containing noble metal elements, such as Ru, Pd and Au, and those of Ag-base alloys containing rare-earth metal elements, such as Sc, Y, Sm, Eu, Tb, Dy, Er and Yb. Those Ag-base alloys have a low electrical resistivity, and the noble metal elements and the rare-earth metal elements added to the Ag-base alloys improves the heat resistance of the Ag-base alloys. Suppression of cohesion during a heat treatment and stability to a heat treatment are of the same technical significance. Improvement of heat resistance is achieved by suppressing the increase of surface roughness due to the cohesion of Ag caused by heating.

Although the low electrical resistivities of the known Ag-(Ru, Pd, Au) alloys and the known Ag-(Sc, Y, Sm, Eu, Tb, Dy, Er, Yb) alloys are satisfactory to some extent, their heat resistances at high temperatures are not satisfactory. JP-A 2002-323611 and JP-A 2004-76080 refer to Ag alloys containing Nd and Ag alloys containing Bi with an intention to suppress the cohesion of Ag and the crystal grain growth of Ag due to heating. Those Ag—Nd alloys and Ag—Bi alloys are indented for forming reflecting electrode films and reflecting films for FPDs. The sizes and required characteristics of the reflecting electrode films and reflecting films are different from those of the interconnecting lines of the interconnecting films. Thus the purpose and uses of the interconnecting films of the present invention are different from those of the prior art alloy films.

### SUMMARY OF THE INVENTION

The present invention has been made in view of those problems and it is therefore an object of the present invention to provide an interconnecting film of an Ag-base alloy having a low electrical resistivity and high heat resistance for FPDs, a sputtering target of the Ag-base alloy for depositing an interconnecting film for FPDs, and a FPD having interconnecting lines formed by processing the interconnecting film of the Ag-base alloy.

The inventors of the present invention found through the examination of Ag-base alloys respectively containing various additive alloy elements that an Ag-base alloy containing Nd in a Nd content in a specific Nd content range and/or Bi in a Bi content in a specific Bi content range has excellent properties.

An interconnecting film according to the present invention for forming interconnecting lines of a FPD is formed of an Ag-base alloy containing 0.1 to 4.0 at % Nd and/or 0.01 to 1.5 at % Bi, and Ag as the remainder. The Ag-base alloy may contain, in addition to Nd and/or Bi, one or some of elements including Cu, Au and Pd in a content in the range of 0.01 to 1.5 at %.

A sputtering target according to the present invention for depositing an interconnecting film for forming interconnecting lines of FPD is formed of an Ag-base alloy containing 0.1 to 4.0 at % Nd and/or 0.1 to 9 at % Bi, and Ag as the remainder. The Ag-base alloy forming the sputtering target may contain, in addition to Nd and/or Bi, one or some of elements including Cu, Au and Pd in a content in the range of 0.01 to 1.5 at %.

A FPD according to the present invention is provided with interconnecting lines formed by processing an interconnecting film of the foregoing-Ag-base alloy.

The interconnecting film of the Ag-base alloy according to the present invention for a FPD has a low electrical resistivity and high heat resistance. Therefore, both the active matrix and the passive matrix FPD provided with the interconnecting lines formed by processing the interconnecting film of the Ag-base alloy have remarkably improved ability and reliability. The sputtering target of the Ag-base alloy according to the present invention is suitable for depositing the interconnecting film of the Ag-base alloy. The interconnecting film of the Ag-base alloy deposited by using the sputtering target has an excellent alloy composition, a satisfactory alloy element distribution, uniform thickness, excellent characteristics and capable of forming interconnecting lines for high-performance FPDs with high reliability The FPD according to the present invention provided with the interconnecting lines formed by processing the interconnecting film of the Ag-base alloy has remarkably improved ability and reliability.

### BRIEF DESCRIPTION OF THE DRAWINGS

The above and other objects, features and advantages of the present invention will become more apparent from the following description taken in connection with the accompanying drawings, in which:

FIG. 1 is a graph showing the dependence of electrical resistivity of various Ag-base alloys on alloy element content;

FIG. 2 is an enlarged, fragmentary, typical plan view of pixels of an active matrix FPD; and

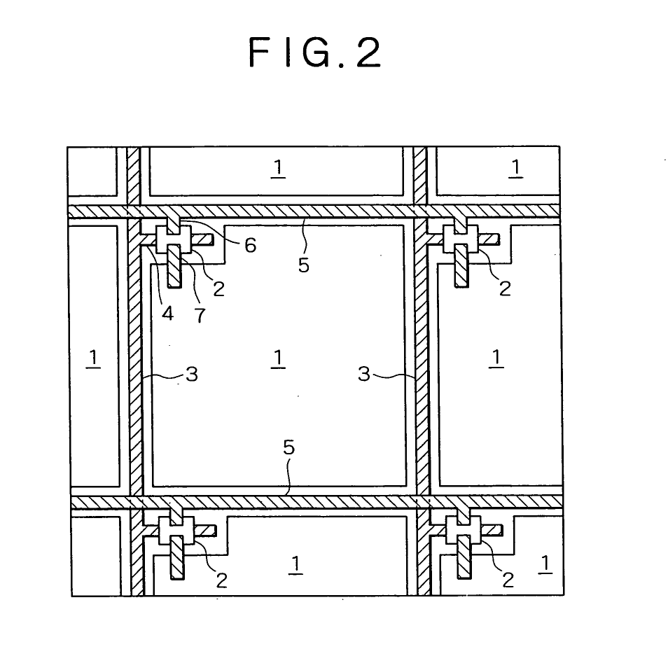

FIG. 3 is an enlarged, fragmentary, typical plan view of pixels of a passive matrix FPD.

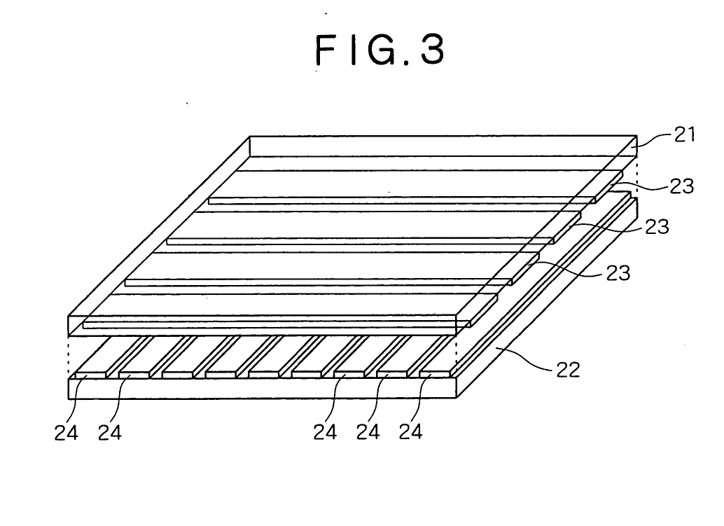

### DESCRIPTION OF THE PREFERRED EMBODIMENTS

An interconnecting film in a preferred embodiment according to the present invention for forming interconnecting lines of a FPD is formed of an Ag-base alloy containing 0.1 to 4.0 at % Nd and/or 0.01 to 1.5 at % Bi, and other elements including Ag and inevitable impurities. The Ag-base alloy may contain, in addition to Nd and/or Bi, 0.01 to 1.5 at % one or some of elements including Cu, Au and Pd.

Nd and/or Bi contained in an Ag-base alloy suppresses increase in the surface roughness of an interconnecting film formed of the Ag-base alloy due to the cohesion of Ag even if the interconnecting film is heated at a high temperature in a vacuum or the atmosphere and improves the heat resistance of the interconnecting film. This highly heat-resistant interconnecting film has a low electrical resistivity. The interconnecting film of the Ag-base alloy containing Nd and/or Bi has a satisfactorily low electrical resistivity and high heat resistance required of the interconnecting film for forming the interconnecting lines of the FPD. When the Ag-base alloy contains Bi, the Ag-base alloy maintains sufficient cohesion resistance even if the Ag-base alloy is subjected to three or more cycles of heating at 450° C. or above and has sufficiently high heat resistance. Thus, the interconnecting lines formed by processing the interconnecting films of the Ag-base alloy according to the present invention improve the ability and reliability of the FPD remarkably.

The effect of Nd on the improvement of heat resistance, i.e., the suppression of increase in surface roughness due to the cohesion of Ag is insignificant when the Nd content is below 0.1 at %. A Nd content above 4.0 at % increases the electrical resistivity of the interconnecting film beyond the upper limit electrical resistivity of 5.0 μΩcm after heating at 300° C. of the permissible electrical resistivity range. Electrical resistivity of the interconnecting film will be represented by a value measured after heating the interconnecting film at 300° C. unless otherwise specified. Therefore, the lower limit of the Nd content is 0.1 at %, preferably, 0.2 at %, and the upper limit of the Nd content is 4.0 at %, preferably, 3.0 at %. A Nd content not greater than 1.5 at % is particularly preferable because electrical resistivity of the interconnecting film of the Al-base alloy is lower than the upper limit electrical resistivity of 3.0 μΩcm. Thus an optimum Nd content is in the range of 0.3 to 0.7 at %.

The effect of Bi on the improvement of heat resistance, i.e., the suppression of increase in surface roughness due to the cohesion of Ag is insignificant when the Bi content is below 0.01 at %. A Bi content above 1.5 at % increases the electrical resistivity of the interconnecting film beyond the upper limit electrical resistivity of 5.0 μΩcm of the permissible electrical resistivity range. Therefore, the lower limit of the Bi content is 0.01 at %, preferably, 0.1 at %, and the upper limit of the Bi content is 1.5 at %, preferably, 1.0 at %. A Bi content not greater than 0.7 at % is particularly preferable because electrical resistivity of the interconnecting film of the Al-base alloy is lower than the upper limit electrical resistivity of 3.0 μΩcm.

Although the reason that the addition of Bi to the Ag-base alloy has an effect on suppressing increase in electrical resistivity after a plurality of cycles of heating is not clearly elucidated, it is inferred that the effect of the addition of Bi to the Ag-base alloy is due to the following phenomenon. When an Ag—Bi alloy thin film of the present invention is formed, a Bi₂O₃ layer is formed on the surface of the Ag—Bi alloy thin film to isolate the Ag—Bi alloy thin film from the atmosphere. Consequently, the Ag—Bi alloy thin film has high cohesion resistance. When the Ag—Bi alloy thin film coated with the Bi₂O₃ layer is heated at a high temperature in the atmosphere, the surface of the Bi₂O₃ layer is further oxidized and densified to isolate the Ag—Bi alloy thin film satisfactorily from the atmosphere. Consequently, the properties of the Ag—Bi alloy thin film will not be deteriorated due to the cohesion of Ag even if the Ag—Bi alloy thin film coated with the dense Bi₂O₃ layer is heated repeatedly at a high temperature.

Thus the interconnecting film of the present invention is a double-layer film consisting of the Ag—Bi alloy film and the Bi₂O₃ layer coating the Ag—Bi alloy film. It is inferred that the Bi content of a surface layer increase and the Bi content of the Ag—Bi alloy film decreases because the Bi₂O₃ layer is formed on the Ag—Bi alloy film and, consequently, the Ag—Bi alloy film has a high electrical conductivity, namely, a low electrical resistivity, comparable to that of Ag. Therefore, it is preferable that the Ag-base alloy for depositing an interconnecting film, for a FPD, which is repeatedly heated in the atmosphere during the manufacturing process, such as an interconnecting film for a FED, contains Bi.

An interconnecting film of the Ag-base alloy having a Nd content in the foregoing Nd content range is etched at a low etching rate by wet etching and side surfaces of interconnecting lines formed by etching the interconnecting film are scarcely etched. Thus the interconnecting film of the Ag-base alloy having an Nd content in the foregoing Nd content range has improved fine patterning. Therefore, it is preferable that the Ag-base alloy for forming the interconnecting lines of FPDs having high resolution contains Nd. An Ag-base alloy containing both Nd and Bi has improved corrosion resistance, namely, high chemical stability.

The elements Cu, Au and Pd further improves the corrosion resistance (chemical stability) of the Ag-base alloy and prevents the halogenation of Ag in an atmosphere containing halogen ions, such as chlorine ions and the cohesion of Ag initiated by halogenation.

A Cu, Au and/or Pd content of below 0.01 at % is ineffective in improving the corrosion resistance and suppressing the cohesion of Ag. The electrical resistivity of the Ag-base alloy is excessively high when the Cu, Ag and/or Pd content is above 1.5 at %. Therefore, a desirable Cu, Au and/or Pd content of is in the range of 0.01 to 1.5 at %, preferably, in the range of 0.05 to 1.2 at %, most preferably, in the range of 0.1 to 1.0 at %.

The relation between the amount of additive elements including Nd and electrical resistivity will be explained. Test films of pure Ag, an Ag—Nd alloy containing 2.2 at % Nd, an Ag—Y alloy containing 2.5 at % Y, an Ag—Ru alloy containing 3.1 at % Ru, an Ag—Pd alloy containing 3.0 at % Pd and an Ag—Au alloy containing 2.9 at % Au were formed in a desired thickness of 300 nm on glass substrates, respectively, by a dc magnetron sputtering process.

The test films were heated by a heat treatment furnace (Naruse Kagaku Kikai K.K.) that heats a specimen at 300° C. for 0.5 h in a vacuum of 0.27×10⁻³ Pa or below, and the electrical resistivities of the test films were measured by the following electrical resistivity measuring method. Sheet resistances Rs of the test films were measured by a dc four-probe method using 3226 MΩ Hi TESTER (Hioki Denki k.k.). Film thickness t was measured by ALPHA-STEP 250 (TENCOR INSTRUMENTS). Electrical resistivity ρ was calculated by using a formula: ρ=(Sheet resistance Rs)×(Film thickness t).

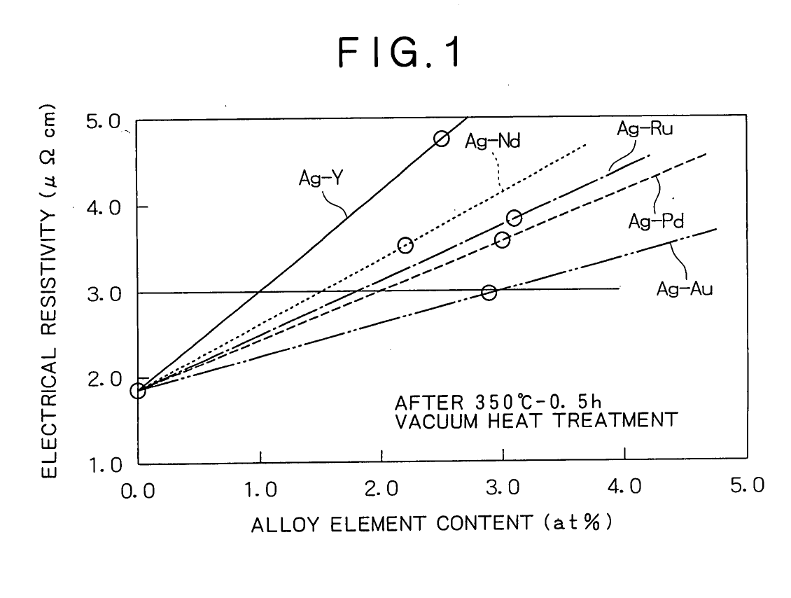

FIG. 1 is a graph showing the variation of electrical resistivities of various Ag-base alloys after heating at 300° C. for 0.5 h in a vacuum with alloy element content determined on the basis of the measured sheet resistances Rs and film thickness t. The electrical resistivity varies linearly with the alloy element content. Upper limit alloy element contents of the Ag-base alloys that make the electrical resistivities of the Ag-base alloys not greater than 5.0 μΩcm are shown below. It was found that the Ag—Nd alloy had a low electrical resistivity of 5.0 μΩcm or below even if the alloy element content was as small as 4.0 at % or below.

The upper limit alloy element contents were 4.0 at % for the Ag—Nd alloy, 2.7 at % for the Ag—Y alloy, 5.0 at % for the Ag—Ru alloy and greater than 5.0 at % for the Ag—Pd and the Ag—Au alloy.

The effect of the Bi content of the Ag-base alloy was examined by the following experiments. Test films of various Ag—Bi alloys were deposited in a desired thickness of 300 nm on glass substrates, respectively, by a dc magnetron sputtering method. The electrical resistivities of the test films were measured. Sheet resistances Rs of the test films were measured by a dc four-probe method using 3226 MΩ Hi TESTER (Hioki Denki k.k.). Film thickness t was measured by ALPHA-STEP 250 (TENCOR INSTRUMENTS). Electrical resistivity ρ was calculatedbyusingaformula: ρ=(SheetresistanceRs)×(Filmthickness t). It was known from the values of electrical resistivity ρ that cohesion did not occurred in any one of the test films before the test films are heated.

The test films were heated at 300° C. for 0.5 h in the atmosphere. The sheet resistances Rs of the test films were measured after heating by the foregoing method, the electrical resistivities of the test films were calculated by using the foregoing formula. The heated test films having an electrical resistivity not higher than 5 μΩcm were evaluated as acceptable and were marked with a circle and those having an electrical resistivity exceeding 5 μΩcm were evaluated as unacceptable and were marked with a cross. Results of evaluation are shown in Table 1.

TABLE 1

| | | Electrical resistivity (μΩcm) | |
|---|---|---|---|
| Sample | | (Heated at 300° C. for | Electrical resistivity |
| No. | Thin film | 0.5 h in the atmosphere) | ≦5 μΩcm |
| 2 | Ag-0.005 at % Bi alloy | Measurement of electrical | x |
| | | resistivity is impos- | |
| | | sible due to cohesion. | |
| 3 | Ag-0.01 at % Bi alloy | 1.7 | ∘ |
| 4 | Ag-0.2 at % Bi alloy | 2.1 | ∘ |
| 5 | Ag-0.5 at % Bi alloy | 2.7 | ∘ |
| 6 | Ag-1.5 at % Bi alloy | 4.8 | ∘ |
| 7 | Ag-3.0 at % Bi alloy | 7.9 | x |

It is known from Table 1 that samples Nos. 3 to 6 have Bi contents within the desire Bi content range and have low electrical resistivities, respectively. A sample No. 7 had a Bi content of 3.0 at % exceeding the upper limit of the desired Bi content range and had a high electrical resistivity. A sample No. 2 had a Bi content of 0.005 at % below the lower limit of the desired Bi content range and cohesion occurred in the film when the film in the sample No. 2 was heated. The sample No. 2 was a discontinuous thin film, was not electrically conducting, the sheet resistance of the sample No. 2 could not be measured and the electrical resistivity could not be determined.

The interconnecting film of the Ag-base alloy for forming the interconnecting lines of a FPD can be deposited on a substrate by a vacuum evaporation method, an ion plating method or a sputtering method. A sputtering method is recommendable. The interconnecting film of the Ag-base alloy deposited by a sputtering method, as compared with thin films deposited by other thin film forming methods, is excellent in alloy composition, alloy element distribution and the uniformity of the thickness, has excellent properties required of the interconnecting film including low electrical resistivity, high heat resistance and excellent fine patterning, and is suitable for forming interconnecting lines for high-performance FPDs with high reliability.

An Ag-base alloy sputtering target for depositing the interconnecting film of the Ag-base alloy can be manufactured by any one of a casting method, a sintering method and a spray forming method. A vacuum-melting and casting method is particularly recommendable. A sputtering target manufactured by a vacuum-melting and casting method contains impurities including nitrogen and oxygen in an impurity content less than that of sputtering targets manufactured by the other methods. Consequently, an interconnecting film deposited by using the sputtering target manufactured by the vacuum-melting and casting method has excellent properties including high heat resistance and excellent fine patterning and is suitable for forming the interconnecting lines of high-performance FPDs with high reliability.

A sputtering target of the Ag-base alloy according to the present invention for depositing the interconnecting film of the Ag-base alloy for forming the interconnecting lines of the FPD contains 0.1 to 4.0 at % Nd and/or 0.1 to 9 at % Bi and Ag as the remainder, and another sputtering target of the Ag-base alloy according to the present invention further contains 0.01 to 1.5 at % Cu, Au and/or Pd.

The sputtering target for depositing the interconnecting film has a Bi content larger than that of the interconnecting film because the Bi content of the interconnecting film deposited by a sputtering method using a sputtering target is only several to several tens percent of the Bi content of the sputtering target. It is inferred that the Bi content of the interconnecting film is smaller than that of the sputtering target because Bi having a melting point greatly different from that of Ag evaporates from the interconnecting film deposited on the substrate, Ag is sputtered at a sputtering yield higher than a sputtering yield at which Bi is sputtered and hence Bi is difficult to sputter, and only Bi is oxidized on the surface of the sputtering target and is not sputtered because Bi, as compared with Ag, is easily oxidizable.

A FPD having interconnecting lines formed by processing the interconnecting film of the Ag-base alloy is capable of exercising excellent performance and has high reliability. There are not particular restrictions on the construction of the FPD of the present invention and the FPD may be of the known construction, provided that the FPD has the interconnecting lines formed by processing the interconnecting film of the Ag-base alloy of the present invention.

The present invention will be described in terms of examples. The present invention is not limited in its practical application to the examples specifically described herein.

### Experiment 1

Test thin films of pure Ag or an Ag-base alloy were deposited in a desired thickness of 300 nm on glass (Corning #1737) substrates of 50.8 mm in diameter and 0.7 mm in thickness by a dc magnetron sputtering method using a sputtering system HSR-552 (Shimazu Seisaku-sho). The dc magnetron sputtering method used a sputtering target of pure Ag of 101.6 mm in diameter and 5 mm in thickness or a sputtering target of pure Ag and a predetermined number of chips of alloy elements of 5 mm×5 mm×1 mm arranged on the sputtering target. Conditions for the dcmagnetron sputtering methodwere base pressure: 0.27×10⁻³ Pa, pressure of Ar gas: 0.27 Pa, flow rate of Ar gas: 30 sccm, sputtering power: 200 W, distance between electrodes: 52 mm and temperature of substrate: room temperature. Properties of the thin films are shown in Table 2 or Table 3. The compositions of samples of the test films excluding Sample No. 1 of the test thin film of pure Ag were analyzed by an inductively coupled plasma emission spectrometry (ICP emission spectrometry) or an inductively coupled plasma mass spectrometry (ICP mass spectrometry). The test thin films were evaluated in terms of heat resistance and fine patterning by the following method.

Heat resistance was evaluated on the basis of increase in surface roughness (average surface roughness Ra). Surface roughness of the test thin film was measured before and after heating in an atomic force microscope observation mode (AFM observation mode) using a scanning probe microscope (Nanoscope IIIa, Digital Instruments). Increase in surface roughness due to heating was calculated by using a formula: (Surface roughness increase)=(Surface roughness after heating)−(Surface roughness before heating). The test thin films were heated in eighteen heating modes specified by combinations of heating conditions including heating temperatures of 350° C., 450° C. and 500° C., heating time of 0.5 h, two types of heating atmosphere, namely, a vacuum atmosphere and an atmospheric atmosphere, and three heating frequencies, namely, one heating cycle, two heating cycles and three heating cycles. Heat resistance was evaluated as acceptable and marked with a circle when increase in surface roughness was 1.0 nm or below or was evaluated as unacceptable and marked with a cross when increase in surface roughness was greater than 1.0 nm. Results of evaluation of the test thin films heated in the vacuum atmosphere are tabulated in Table 2 and those of the test thin films heated in the atmospheric atmosphere are tabulated in Table 3.

TABLE 2

| | | Surface roughness increase due to heating in a vacuum (nm) | | | | | | | | | |
|---|---|---|---|---|---|---|---|---|---|---|---|
| | | 350° C.-0.5 h | | | 450° C.-0.5 h | | | 500° C.-0.5 h | | | Heat |
| Sample | | One | Two | Three | One | Two | Three | One | Two | Three | resis- |
| No. | Thin film | cycle | cycles | cycles | cycle | cycles | cycles | cycle | cycles | cycles | tance |
| 1 | Pure Ag | 2.8 | 3.3 | 3.7 | 4.2 | 4.9 | 5.8 | 4.6 | 5.5 | 6.6 | x |
| 2 | Ag-0.04 at % Nd alloy | 1.6 | 1.9 | 2.1 | 2.4 | 2.7 | 3.2 | 2.6 | 3.1 | 3.7 | x |
| 3 | Ag-0.1 at % Nd alloy | 0.5 | 0.6 | 0.6 | 0.6 | 0.6 | 0.7 | 0.6 | 0.7 | 0.8 | ∘ |
| 4 | Ag-0.5 at % Nd alloy | 0.2 | 0.3 | 0.3 | 0.3 | 0.4 | 0.4 | 0.4 | 0.5 | 0.7 | ∘ |
| 5 | Ag-1.5 at % Nd alloy | 0.05 | 0.07 | 0.10 | 0.08 | 0.10 | 0.20 | 0.10 | 0.15 | 0.22 | ∘ |
| 6 | Ag-3.0 at % Nd alloy | 0.04 | 0.07 | 0.09 | 0.08 | 0.09 | 0.18 | 0.09 | 0.15 | 0.20 | ∘ |
| 7 | Ag-1.0 at % Y alloy | 1.3 | 1.5 | 1.8 | 1.5 | 1.7 | 2.0 | 1.8 | 2.2 | 2.5 | x |
| 8 | Ag-1.8 at % Ru alloy | 2.0 | 2.3 | 2.5 | 2.4 | 2.8 | 3.1 | 3.1 | 3.3 | 3.6 | x |
| 9 | Ag-2.0 at % Pd alloy | 1.5 | 1.8 | 2.2 | 1.8 | 2.2 | 2.5 | 2.3 | 2.5 | 2.9 | x |
| 10 | Ag-3.0 at % Au alloy | 1.8 | 2.0 | 2.3 | 2.1 | 2.4 | 2.6 | 2.5 | 2.8 | 3.1 | x |
| 11 | Ag-0.5 at % Nd-0.7 at % Cu alloy | 0.2 | 0.3 | 0.3 | 0.3 | 0.4 | 0.4 | 0.4 | 0.5 | 0.7 | ∘ |
| 12 | Ag-0.5 at % Nd-0.3 at % Au alloy | 0.2 | 0.3 | 0.3 | 0.3 | 0.4 | 0.4 | 0.4 | 0.5 | 0.7 | ∘ |
| 13 | Ag-0.5 at % Nd-0.5 at % Pd alloy | 0.2 | 0.3 | 0.3 | 0.3 | 0.4 | 0.4 | 0.4 | 0.5 | 0.7 | ∘ |
| 14 | Ag-0.5 at % Nd-0.1 at % Bi alloy | 0.2 | 0.3 | 0.3 | 0.3 | 0.4 | 0.4 | 0.4 | 0.5 | 0.7 | ∘ |

TABLE 3

| | | Surface roughness increase due to heating in the atmosphere (nm) | | | | | | | | | |
|---|---|---|---|---|---|---|---|---|---|---|---|
| | | 350° C.-0.5 h | | | 450° C.-0.5 h | | | 500° C.-0.5 h | | | Heat |
| Sample | | One | Two | Three | One | Two | Three | One | Two | Three | resis- |
| No. | Thin film | cycle | cycles | cycles | cycle | cycles | cycles | cycle | cycles | cycles | tance |
| 1 | Pure Ag | 4.4 | 4.8 | 5.3 | 5.9 | 6.4 | 6.9 | 6.2 | 7.7 | 8.0 | x |
| 2 | Ag-0.04 at % Nd alloy | 2.5 | 2.7 | 3.0 | 3.3 | 3.5 | 3.8 | 3.4 | 4.2 | 4.4 | x |
| 3 | Ag-0.1 at % Nd alloy | 0.6 | 0.6 | 0.7 | 0.7 | 0.7 | 0.8 | 0.7 | 0.8 | 0.9 | ∘ |
| 4 | Ag-0.5 at % Nd alloy | 0.3 | 0.4 | 0.5 | 0.4 | 0.4 | 0.6 | 0.6 | 0.7 | 0.7 | ∘ |
| 5 | Ag-1.5 at % Nd alloy | 0.07 | 0.11 | 0.15 | 0.09 | 0.12 | 0.25 | 0.14 | 0.22 | 0.29 | ∘ |
| 6 | Ag-3.0 at % Nd alloy | 0.07 | 0.10 | 0.14 | 0.08 | 0.12 | 0.24 | 0.14 | 0.22 | 0.28 | ∘ |
| 7 | Ag-1.0 at % Y alloy | 1.5 | 1.8 | 2.1 | 1.8 | 2.0 | 2.4 | 1.9 | 2.4 | 2.9 | x |
| 8 | Ag-1.8 at % Ru alloy | 2.3 | 2.5 | 2.8 | 2.3 | 2.6 | 3.1 | 2.6 | 3.0 | 3.2 | x |
| 9 | Ag-2.0 at % Pd alloy | 1.7 | 2.0 | 2.2 | 2.1 | 2.3 | 2.5 | 2.1 | 2.6 | 2.9 | x |
| 10 | Ag-3.0 at % Au alloy | 1.9 | 2.2 | 2.4 | 2.2 | 2.5 | 2.8 | 2.4 | 2.8 | 3.0 | x |
| 11 | Ag-0.5 at % Nd-0.7 at % Cu alloy | 0.3 | 0.4 | 0.5 | 0.4 | 0.4 | 0.6 | 0.6 | 0.7 | 0.7 | ∘ |
| 12 | Ag-0.5 at % Nd-0.3 at % Au alloy | 0.3 | 0.4 | 0.5 | 0.4 | 0.4 | 0.6 | 0.6 | 0.7 | 0.7 | ∘ |
| 13 | Ag-0.5 at % Nd-0.5 at % Pd alloy | 0.3 | 0.4 | 0.5 | 0.4 | 0.4 | 0.6 | 0.6 | 0.7 | 0.7 | ∘ |
| 14 | Ag-0.5 at % Nd-0.1 at % Bi alloy | 0.3 | 0.4 | 0.5 | 0.4 | 0.4 | 0.6 | 0.6 | 0.7 | 0.7 | ∘ |

It is known from Tables 2 and 3 that Samples Nos. 3, 4 and 5 of the test thin films according to the present invention and Sample No. 6 of the test thin film in a comparative example are excellent in heat resistance owing to the effect of addition of Nd to the Ag-base alloy. Sample No. 6 containing 3.0 at % Nd has an excessively high electrical resistivity. The heat resistance of Sample No. 2 containing 0.04 at % Nd is unsatisfactory due to excessively small Nd content. Samples Nos. 11, 12, 13 and 14 according to the present invention containing a third alloy element exhibited high heat resistance in heat treatments under all the heating conditions.

Addition of alloy elements to the Ag-base alloys forming Samples Nos. 7, 8, 9 and 10 in comparative examples and achieving the desired low electrical resistivity is not effective in improving heat resistance. Samples Nos. 7, 8, 9 and 10 are not satisfactory in heat resistance in heat treatments under all the heating conditions.

Fine patterning was evaluated by the following method. A patterned photoresist film having 10 μm wide stripes arranged at spacings of 10 μm was formed on each of the test thin films by a photolithographic process including the sequential steps of applying a photoresist to the surface of the test thin film in a photoresist film, prebaking the photoresist film, exposing the photoresist film to ultraviolet light, developing the exposed photoresist film to form a patterned photoresist film, cleaning the patterned photoresist film and drying the patterned photoresist film. A photoresist AZP 4110 (Clariant Japan K. K.) and an AZ developer (Clariant Japan K. K.) were used. The test thin film was etched by a wet etching process including the sequential steps of wet-etching the test thin film, cleaning the etched test thin film, drying the etched test thin film, removing the photoresist film and drying the etched test thin film. A mixed acid solution containing 800 parts phosphoric acid, 3 parts nitric acid and 20 parts deionized water was used as an etchant.

Time needed to wet-etch the test thin film completely was measured and etching rate was calculated by using a formula: (Etching rate) (Thickness of the test thin film)/(Time for completely etching the test thin film). SEM micrographs of the wet-etched test thin films were taken and the widths of lines in the SEM micrographs were measured. Side etching ratio was calculated by using a formula: (Side etching ratio)=(Width in micrometer of an originally 10 μm wide etched line)/10 μm×100 (%). The fine patterning was evaluated in terms of wet-etching rate and side etching ratio. The test thin films satisfying wet-etching rate of 3 nm/s or below, which is below a wet-etching rate of 10.0 nm/s at which thin films of pure Ag are etched, and side etching ratios smaller than 10% were evaluated as excellent in fine patterning and were marked with a circle, and the test thin films not satisfying those conditions were evaluated as unsatisfactory in fine patterning and were marked with a cross. Measured data and results of evaluation are shown in Table 4.

TABLE 4

| Sample | | Wet-etching | Side etching | Fine |
|---|---|---|---|---|
| No. | Thin film | rate (nm/s) | ratio (%) | patterning |
| 1 | Pure Ag | 10.0 | 30 | x |
| 2 | Ag-0.04 at % Nd alloy | 6.1 | 18 | x |
| 3 | Ag-0.1 at % Nd alloy | 2.3 | 7 | ∘ |
| 4 | Ag-0.5 at % Nd alloy | 2.0 | 6 | ∘ |
| 5 | Ag-1.5 at % Nd alloy | 1.8 | 5 | ∘ |
| 6 | Ag-3.0 at % Nd alloy | 1.5 | 4 | ∘ |
| 7 | Ag-1.0 at % Y alloy | 4.2 | 15 | x |
| 8 | Ag-1.8 at % Ru alloy | 7.2 | 20 | x |
| 9 | Ag-2.0 at % Pd alloy | 7.5 | 22 | x |
| 10 | Ag-3.0 at % Au alloy | 9.5 | 25 | x |
| 11 | Ag-0.5 at % Nd-0.7 | 2.0 | 6 | ∘ |
| | at % Cu alloy | | | |
| 12 | Ag-0.5 at % Nd-0.3 | 2.5 | 8 | ∘ |
| | at % Au alloy | | | |
| 13 | Ag-0.5 at % Nd-0.5 | 2.3 | 7 | ∘ |
| | at % Pd alloy | | | |
| 14 | Ag-0.5 at % Nd-0.1 | 2.0 | 6 | ∘ |
| | at % Bi alloy | | | |

It is known from Table 4 that Samples Nos. 3, 4 and 5 of in examples of the present invention and Sample No. 6 in a comparative example have improved fine patterning owing to the addition of Nd to the Ag-base alloys forming the thin films. The Nd content of Sample No. 6 is excessively large and Sample No. 6 has an excessively high electrical resistivity. The Nd content of 0.04 at % of Sample No. 2 is excessively small and the fine patterning of Sample No. 2 is unsatisfactory. The Ag-base alloys containing a third alloy element and forming Samples Nos. 11, 12, 13 and 14 of examples of the present invention contain 0.5 at % Nd. Samples Nos. 11, 12, 13 and 14 of those thin films have satisfactory fine patterning. Although Samples Nos. 7, 8, 9 and 10 in comparative examples have satisfactorily low electrical resistivities, even Sample No. 7 having comparatively improved fine patterning is not excellent in fine patterning.

### Experiment 2

Fabrication of Test Thin Films

Test thin films of pure Ag or an Ag-base alloy shown in Table 5 were deposited in a desired thickness of 300 nm on glass (Corning #1737) substrates of 50.8 mm in diameter and 0.7 mm in thickness by a dc magnetron sputtering method using a sputtering system HSM-552 (Shimazu Seisaku-sho) The dc magnetron sputtering method used a sputtering target of pure Ag of 101.6 mm in diameter and 5 mm in thickness, a composite sputtering target of including a pure Ag sputtering target and a predetermined number of chips of alloy elements of 5 mm×5 mm×1 mm arranged on the Ag sputtering target. Conditions for the dc magnetron sputtering method were base pressure: 0.27×10⁻³ Pa, pressure of Ar gas: 0.27 Pa, flow rate of Ar gas: 30 sccm, sputteringpower: 200W dc, distance between electrodes: 52 mm and temperature of substrate: 150° C. Properties of the thin films are shown in Table 5. The compositions of samples of the test films excluding Sample No. 1 of the test thin film of pure Ag were analyzed by an inductively coupled plasma arc emission spectrometry (ICP emission spectrometry) or an inductively coupled plasma mass spectrometry (ICP mass spectrometry). The test thin films were evaluated in terms of cohesion resistance and electrical resistivity.

Cohesion Resistance

The present invention defines cohesion resistance by the term: “ability to suppress the cohesion of Ag due to heating and to suppress increase in surface roughness (average surface roughness Ra)”. Cohesion resistance was evaluated in terms of increase in surface roughness. Surface roughness of test thin films was measured before and after heating. Surface roughness of the test thin film was measured in an AFM observation mode) using a scanning probe microscope (Nanoscope IIIa, Digital Instruments). Then, the test thin films were heated in fifteen heating modes specified by combinations of the following conditions.
Atmosphere: Atmospheric atmosphere (one condition)
Heating temperature: 450° C., 500° C. and 550° C. (three conditions)
Heating time: 0.5 h (one condition)
Number of heating cycle: 1, 2, 3, 4 and 5 (five conditions)

Surface roughness of the test thin film was measured by the aforesaid method, increase in surface roughness due to heating was calculated by using a formula: (Surface roughness increase)=(Surface roughness after heating)−(Surface roughness before heating). The test thin films were evaluated as acceptable and were marked with a circle when the surface roughness increase was 1.0 nm or below. The test thin films were evaluated as unacceptable and were marked with a cross when the surface roughness increase was greater than 1.0 nm. Results of evaluation of cohesion resistance when the test thin films were heated in the atmosphere are tabulated in table 5.

TABLE 5

| | | Surface roughness increase due to heating in the atmosphere (nm) | | | | | | | | | | | | | | | |
|---|---|---|---|---|---|---|---|---|---|---|---|---|---|---|---|---|---|
| | | 450° C.-0.5 h | | | | | 500° C.-0.5 h | | | | | 550° C.-0.5 h | | | | | Cohe- |
| Sam- | | One | Two | Three | Four | Five | One | Two | Three | Four | Five | One | Two | Three | Four | Five | sion |
| ple | | cy- | cy- | cy- | cy- | cy- | cy- | cy- | cy- | cy- | cy- | cy- | cy- | cy- | cy- | cy- | resis- |
| No. | Thin film | cle | cles | cles | cles | cles | cle | cles | cles | cles | cles | cle | cles | cles | cles | cles | tance |
| 1 | Pure Ag | 5.9 | 6.4 | 6.9 | 8.1 | 9.3 | 6.2 | 7.7 | 8.0 | 9.4 | 10.9 | 7.7 | 9.2 | 9.5 | 11.0 | 12.3 | x |
| 2 | Ag-0.005 at % Bi alloy | 2.5 | 2.7 | 3.0 | 3.5 | 4.3 | 3.3 | 3.5 | 3.8 | 4.3 | 5.0 | 3.4 | 4.2 | 4.4 | 5.1 | 6.9 | x |
| 3 | Ag-0.01 at % Bi alloy | 0.6 | 0.6 | 0.7 | 0.7 | 0.8 | 0.7 | 0.7 | 0.8 | 0.9 | 1.0 | 0.7 | 0.8 | 0.9 | 0.9 | 1.0 | ∘ |
| 4 | Ag-0.2 at % Bi alloy | 0.4 | 0.5 | 0.6 | 0.6 | 0.7 | 0.5 | 0.5 | 0.7 | 0.8 | 0.9 | 0.6 | 0.7 | 0.8 | 0.8 | 0.9 | ∘ |
| 5 | Ag-0.5 at % Bi alloy | 0.3 | 0.4 | 0.5 | 0.5 | 0.6 | 0.4 | 0.4 | 0.6 | 0.7 | 0.8 | 0.6 | 0.7 | 0.7 | 0.8 | 0.9 | ∘ |
| 6 | Ag-1.5 at % Bi alloy | 0.07 | 0.11 | 0.15 | 0.21 | 0.30 | 0.09 | 0.12 | 0.25 | 0.34 | 0.51 | 0.14 | 0.22 | 0.29 | 0.41 | 0.52 | ∘ |
| 7 | Ag-3.0 at % Bi alloy | 0.07 | 0.10 | 0.14 | 0.17 | 0.20 | 0.08 | 0.12 | 0.24 | 0.30 | 0.35 | 0.14 | 0.22 | 0.28 | 0.35 | 0.44 | ∘ |
| 8 | Ag-0.5 at % Nd alloy | 0.4 | 0.4 | 0.6 | 1.1 | 1.3 | 0.6 | 0.7 | 0.7 | 1.2 | 1.5 | 0.7 | 0.8 | 0.9 | 1.4 | 1.8 | x |
| 9 | Ag-0.5 at % Sm alloy | 1.8 | 2.0 | 2.4 | 2.8 | 3.2 | 1.9 | 2.4 | 2.9 | 3.3 | 3.9 | 2.2 | 2.7 | 3.2 | 3.9 | 4.5 | x |
| 10 | Ag-0.5 at % Cu alloy | 2.1 | 2.4 | 2.8 | 3.5 | 4.1 | 2.2 | 2.7 | 3.5 | 4.1 | 5.2 | 2.5 | 3.1 | 3.3 | 4.7 | 6.0 | x |
| 11 | Ag-0.5 at % Au alloy | 2.2 | 2.5 | 2.8 | 3.4 | 4.1 | 2.4 | 2.8 | 3.0 | 4.0 | 5.3 | 2.6 | 3.1 | 3.4 | 4.7 | 6.1 | x |
| 12 | Ag-0.5 at % Pd alloy | 2.1 | 2.3 | 2.5 | 3.4 | 4.2 | 2.1 | 2.6 | 3.9 | 4.1 | 5.3 | 2.6 | 3.0 | 3.2 | 4.7 | 6.0 | x |
| 13 | Ag-0.2 at % Bi- | 0.3 | 0.4 | 0.5 | 0.5 | 0.6 | 0.4 | 0.4 | 0.6 | 0.7 | 0.8 | 0.6 | 0.7 | 0.7 | 0.8 | 0.9 | ∘ |
| | 1.0 at % Cu alloy | | | | | | | | | | | | | | | | |
| 14 | Ag-0.2 at % Bi- | 0.3 | 0.4 | 0.5 | 0.5 | 0.6 | 0.4 | 0.4 | 0.6 | 0.7 | 0.8 | 0.6 | 0.7 | 0.7 | 0.8 | 0.9 | ∘ |
| | 1.0 at % Au alloy | | | | | | | | | | | | | | | | |
| 15 | Ag-0.2 at % Bi- | 0.3 | 0.4 | 0.5 | 0.5 | 0.6 | 0.4 | 0.4 | 0.6 | 0.7 | 0.8 | 0.6 | 0.7 | 0.7 | 0.8 | 0.9 | ∘ |
| | 1.0 at % Pd alloy | | | | | | | | | | | | | | | | |

It is known from Table 5 that the test thin films in Samples Nos. 3 to 7 formed of Ag-base alloys containing not less than 0.01 at % Bi have excellent cohesion resistance regardless of heating conditions. The Bi content of Sample No. 7 formed of an Ag-base alloy containing 3.0 at % Bi is excessive and Sample No. 7 has an excessively high electrical resistivity. The test thin film in Sample No. 1 formed of pure Ag and not containing Bi and the test thin film in Sample No. 2 having a low Bi content of 0.005 at % are unsatisfactory in cohesion resistance. The test thin films in Sample Nos. 13 to 15 formed of Ag-base alloys having a specified Bi content and containing at least one of third alloy elements including Cu, Au and Pd have high cohesion resistance regardless of heating conditions. The test thin films in Samples Nos. 8 to 12 containing one of those third alloy elements and not containing Bi are inferior in cohesion resistance.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

1. An interconnecting film, for forming interconnecting lines of a FPD, formed of an Ag-base alloy containing 0.1 to 4.0 at % Nd and/or 0.01 to 1.5 at % Bi, and Ag as the remainder.

2. The interconnecting film according to claim 1, wherein the Ag-base alloy contains, in addition to Nd and/or Bi, one or some of elements including Cu, Au and Pd in a content in the range of 0.01 to 1.5 at %.

3. A sputtering target, for depositing an interconnecting film for forming interconnecting lines of FPD, formed of a Ag-base alloy containing 0.1 to 4.0 at % Nd and/or 0.1 to 9 at % Bi, and Ag as the remainder.

4. The sputtering target according to claim 3, wherein the Ag-base alloy contains, in addition to Nd and/or Bi, one or some of elements including Cu, Au and Pd in a content in the range of 0.01 to 1.5 at %.

5. A flat panel display comprising interconnecting lines formed by processing an interconnecting film of the Ag-base alloy stated in claim 1.
